(19) United States
(12) Patent Application Publication
(10) Pub. No.: US 2020/0270417 A1
(43) Pub. Date: Aug. 27, 2020

(54) FLAME-RETARDANT POLYAMIDE COMPOSITIONS

(71) Applicant: LANXESS Deutschland GmbH, Cologne (DE)

(72) Inventors: Jochen ENDTNER, Cologne (DE); Matthias BIENMUELLER, Krefeld (DE)

(73) Assignee: LANXESS Deutschland GmbH, Cologne (DE)

(21) Appl. No.: 16/839,335

(22) Filed: Apr. 3, 2020

Related U.S. Application Data
(63) Continuation of application No. 15/128,190, filed on Sep. 22, 2016.

(30) Foreign Application Priority Data
Mar. 27, 2014 (EP) 14161895.9

(51) Int. Cl. C08K 3/34; C08K 7/14; C08K 3/38; C08K 9/06; C08K 3/22; C08L 77/02; C08K 3/016; C08K 5/00; C08K 5/13

(52) U.S. Cl. CPC C08K 3/34; C08K 7/14; C08K 3/38; C08K 9/06; C08K 3/22; C08L 77/02; C08K 2201/001; C08K 5/0066; C08K 5/13; C08K 2003/2227; C08K 2003/2224; C08K 2003/385; C08K 3/016

(57) ABSTRACT

The present invention relates to polyamide-based compositions comprising at least one filler from the group consisting of aluminum oxide, boron nitride and triclinic aluminum silicate and also the use of these compositions for producing products having relatively high flame resistance requirements, particularly preferably products having relatively high glow wire requirements, in particular components for electric current- and voltage-conducting components in domestic appliances.

This application is a continuation of pending U.S. patent application Ser. No. 15/128,190 filed Sep. 22, 2016, with the same title, which claims the right of priority under 35 U.S.C. § 119 (a)-(d) and 35 U.S.C. § 365 of International Application No. PCT/EP2015/055523, filed Mar. 17, 2015, which is entitled to the right of priority of European Patent Application No. 14161895.9 filed Mar. 27, 2014, the contents of which are hereby incorporated by reference in their entirety.

The present invention relates to polyamide-based compositions comprising at least one filler from the group consisting of aluminum oxide, boron nitride and aluminum silicate and also the use of these compositions for producing products having relatively high flame resistance requirements, particularly preferably products having relatively high glow wire requirements, in particular components for electric current- and voltage-conducting components in domestic appliances.

Polyamide compositions are used because of, inter alia, their excellent properties in respect of strength, toughness, processability and their very good resistance to solvents, in a variety of applications from the automobile sector through to the electrical and electronics field. In the electrical and electronics field, in particular, there are often increased requirements in respect of the flame resistance of the nonmetallic, insulating materials, working materials or products because of the increased fire risks triggered, for example, by short circuits, electric arcs or damaged lines.

Particularly for electric current- and voltage-conducting components in domestic appliances, the nonmetallic, insulating materials used for this purpose have to meet the standardized requirements in respect of their fire resistance in accordance with IEC60335-1 when the distance between the material and power-conducting parts is less than 3 mm (see Plastverarbeiter, 56. Year 2005, No. 4, 66-67)

In domestic appliances subject to supervision which carry currents above 0.5 A, the nonmetallic, insulating materials and the products made therefrom have to achieve a GWFI (glow wire flammability index=IEC60695-2-12) of at least 750° C. The GWFI is measured in accordance with IEC60695-2-12 on a test plate (round disk) and is a measure of the self-extinguishing behavior of a sample when acted on by a glowing wire. The test specimen is pressed against a heated glow wire with a force of one newton for 30 seconds. The penetration depth of the glow wire is limited to 7 mm. The test is passed when the test specimen continues to burn for less than 30 seconds after removal of the glow wire and when a sheet of tissue paper underneath the test specimen does not ignite.

High or relatively high flame resistance requirements for the purposes of the present invention are therefore a GWFI>750° C., with this parameter being determined in accordance with IEC60695-2-12. If a material to be examined or a product to be examined does not meet this condition in accordance with IEC 60695-2-12, corresponding approval cannot be given.

As an alternative, the product to be examined can also be subjected to a GWT Test (glow wire temperature test=IEC60695-2-11). For domestic appliances subject to supervision carrying currents above 0.5 A, a GWT of at least 750° C. has to be withstood in this case by the nonmetallic, insulating materials. In addition, it may be commented that in the case of domestic appliances which are not subject to supervision, the glow wire inflammability also plays a role. This can, for example, be determined in accordance with IEC60695-2-13 on a test plate.

Owing to their chemical composition, many plastics, for example polyamide, are readily combustible. To be able to attain the high flame resistance requirements demanded by plastics processors and sometimes by legislators, plastics are therefore generally provided with flame retardants. In the case of polyamides, halogen-containing flame retardants such as brominated polystyrenes or decabromodiphenylethane come into question and are usually used in combination with a flame retardant synergist, e.g. antimony trioxide.

Among nonhalogenated flame retardants, nitrogen-containing derivatives, in particular melamine cyanurate, water-liberating compounds, in particular magnesium hydroxide, or phosphorus-containing components, in particular red phosphorus, melamine polyphosphate or the salts of phosphinic acids (phosphinates) are frequently used for polyamides (DE-A-2 252 258 and DE-A-2 447 727).

A disadvantage of the use of these flame retardants is, in particular, the low decomposition temperature imposed by the system and, associated therewith, a narrow processing window for molding compositions containing such flame retardants in compounding, in injection molding or in extrusion. Compounding (from compound=mixture) is a term from plastics technology which can be equated with plastics processing and which describes the upgrading process of plastics by admixing of auxiliaries (fillers, additives and so on) for targeted optimization of the property profiles of the plastics. Compounding is performed in at least one mixing apparatus, preferably in extruders, particularly preferably in corotating twin-screw extruders, counterrotating twin-screw extruders, planetary screw extruders or cocompounders and comprises the process operations conveying, melting, dispersing, mixing, degassing and pressure build-up.

Thus, in the processing or compounding of the halogen-free flame retardant melamine cyanurate in polyamides, decomposition phenomena of compositions to be used with disadvantageous effects such as deposit formation and foaming can occur at temperatures above only 290° C.

Analogously, the industrial usability of the halogen-free flame retardant magnesium hydroxide is often restricted to low-melting polyamides such as polyamide 6. A further disadvantage of magnesium hydroxide in particular is the adverse effects on mechanical properties, in particular the impact toughness and the edge fiber elongation, of the products obtainable from polyamide compositions to which magnesium hydroxide has been added.

In the use of phosphinate-containing flame retardants, too, polymer degradation, discoloration of the polymer and smoke evolution during processing have sometimes been observed, particularly at processing temperatures above 300° C. However, these difficulties can be reduced by addition of small amounts of basic or amphoteric oxides, hydroxides, carbonates, silicates, borates or stannates (WO-A 2004/022640).

Independently of processing questions, many flame retardants customarily used are also under discussion for ecological reasons. Thus, some halogen-containing flame retardants can accumulate in organisms on introduction into the environment owing to their high persistence. In the case of halogen-free flame retardants based on phosphorus, the energy-intensive production, inter alia, is a disadvantage.

US 2011/103021 A1 describes a heat sink for an electric or electronic device. Example II there relates to a molding composition composed of polyamide 46 and boron nitride. The composition is mixed in an extruder and subjected to an injection molding process in order to produce test plates. The glow wire resistance was determined by means of the glow wire test GWFI in accordance with IEC 60695-2, which was passed both at 650° C. and also at 960° C.

WO 2013/045426 A1 discloses a composition containing a polyamide, a metal oxide such as aluminum oxide and a nitride compound such as boron nitride. Further components comprise fibers such as glass fibers, flame retardants and thermal stabilizers.

CN 103 304 992 A describes a flame-resistant polyamide composition containing polyamide 66, a flame retardant, an accelerator having a low carbon content, an antioxidant and from 1 to 3% by weight of a GWIT auxiliary such as aluminum oxide.

U.S. Pat. No. 4,399,246 A describes a polyamide composition containing a mineral filler, an aminosilane and a sulfonamide compound. Compositions composed of polyamide and aluminum silicate are described in examples 2 and 3. The compositions are mixed in an extruder at 270-280° C. and extruded to form test specimens by means of injection molding.

US 2006/189747 A discloses polyamide compositions comprising kaolin.

Proceeding from this prior art, it was therefore an object of the present invention to provide polyamide-based compositions for use in applications having relatively high flame resistance requirements, in particular the requirements in accordance with IEC60335-1, which preferably meet the above-described relatively high flame resistance requirements without addition of flame-retardants based on halogen-, nitrogen- or phosphorus-containing organic compounds or red phosphorus.

It has now surprisingly been found that polyamide-based compositions and products made therefrom which contain at least one electrically insulating thermally conductive filler from the group consisting of aluminum oxide, boron nitride and aluminum silicate, preferably aluminum silicate, meet relatively high flame resistance requirements, in particular an increased glow wire resistance, without the usual restrictions in respect of processing window or ecology when using flame retardants having to be accepted.

The object is achieved by the invention providing compositions containing
a) at least one polyamide and
b) at least one electrically insulating, thermally conductive filler selected from the group consisting of aluminum oxide, boron nitride and aluminum silicate.

The present invention preferably provides compositions containing
a) at least one polyamide and
b) triclinic pinacoidal aluminum silicate.

For clarity, it should be noted that the scope of the present invention encompasses all the definitions and parameters mentioned hereinafter in general terms or specified within areas of preference, in any desired combinations.

The present invention preferably provides compositions containing
a) from 20 to 90% by weight, preferably from 30 to 70% by weight, of at least one polyamide and
b) from 10 to 80% by weight, preferably from 15 to 75% by weight, particularly preferably from 30 to 70% by weight, of at least one electrically insulating, thermally conductive filler selected from the group consisting of b1) aluminum oxide, b2) boron nitride and b3) aluminum silicate,

where the sum of all percentages by weight is always 100.

The present invention particularly preferably provides compositions containing

a) from 20% to 90% by weight, preferably from 30% to 70% by weight, of at least one polyamide and

b) from 10% to 80% by weight, preferably from 15% to 75% by weight, particularly preferably from 30% to 70% by weight, of triclinic pinacoidal aluminum silicate,

where the sum of all percentages by weight is always 100.

The present invention additionally provides for the use of a) at least one polyamide and b) at least one electrically insulating, thermally conductive filler selected from the group consisting of aluminum oxide, boron nitride and triclinic aluminum silicate for producing products which meet relatively high flame resistance requirements, preferably without additional flame retardants based on halogen-, nitrogen- or phosphorus-containing organic compounds or red phosphorus.

The invention preferably provides for the use of compositions containing
a) from 20 to 90% by weight, preferably from 30 to 70% by weight, of at least one polyamide and
b) from 10 to 80% by weight, preferably from 15 to 75% by weight, particularly preferably from 30 to 70% by weight, of at least one electrically insulating, thermally conductive filler selected from the group consisting of b1) aluminum oxide, b2) boron nitride and b3) aluminum silicate,

where the sum of all percentages by weight is always 100, for producing products which meet relatively high flame resistance requirements, preferably without additional flame retardants based on halogen-, nitrogen- or phosphorus-containing organic compounds or red phosphorus.

The invention preferably provides for the use of compositions containing
a) from 20 to 90% by weight, preferably from 30 to 70% by weight, of at least one polyamide and
b) from 10% to 80% by weight, preferably from 15% to 75% by weight, particularly preferably from 30% to 70% by weight, of triclinic pinacoidal aluminum silicate,

where the sum of all percentages by weight is always 100, for producing products which meet relatively high flame resistance requirements, preferably without additional flame retardants based on halogen-, nitrogen- or phosphorus-containing organic compounds or red phosphorus.

The compositions according to the invention are formulated for further utilization by mixing the components a) and b) to be used as starting materials in at least one mixing apparatus. This gives, as intermediates, molding compositions based on the compositions according to the invention. These molding compositions can either consist entirely of the components a) and b) or else contain further components in addition to the components a) and b). In this case, the components a) and b) have to be varied within the quantity ranges indicated in such a way that the sum of all percentages by weight is always 100.

The invention therefore additionally provides polyamide molding compositions intended for use in extrusion, in blow molding or in injection molding, preferably in pelletized form, containing the compositions of the invention which make up from 50 to 100% by weight, preferably from 60 to 100% by weight, particularly preferably from 70 to 100% by weight, of the polyamide molding compositions of the invention or provided according to the invention for producing relatively high flame protection requirements, in particular provided with an increased glow wire resistance, without the restrictions in respect of processing window or ecology which are usual when using flame retardants having to be accepted. In one embodiment, the present invention provides compositions containing
c) from 5% to 70% by weight, preferably from 10% to 45% by weight, particularly preferably from 15% to 35% by weight, in each case based on the total composition, of glass fibers in addition to the components a) and b), where the amounts of the other components are reduced to such an extent that the sum of all percentages by weight is always 100.

In one embodiment, the present invention relates to compositions comprising, in addition to components a) to c) or instead of component c), also
d) from 0.01% to 3% by weight, preferably from 0.05% to 1.5% by weight, particularly preferably from 0.1% to 0.8% by weight, in each case based on the total composition, of at least one thermal stabilizer, where the amounts of the other components are reduced to such an extent that the sum of all percentages by weight is always 100.

In one embodiment, the present invention provides compositions containing
e) from 1% to 40% by weight, preferably from 2% to 30% by weight, particularly preferably from 5% to 20% by weight, in each case based on the total composition, of at least one flame retardant in addition to the components a) to d) or instead of c) and/or d) in order to increase the flame retardant effect, where the amounts of the other components are reduced to such an extent that the sum of all percentages by weight is always 100.

In one embodiment, the present invention provides compositions containing
f) from 0.01% to 20% by weight, preferably from 0.01% to 10% by weight, particularly preferably from 0.01% to 5% by weight, in each case based on the total composition, of at least one other additive different from the components b) to e) in addition to the components a) to e) or instead of c) and/or d) and/or e), where the amounts of the other components are reduced to such an extent that the sum of all percentages by weight is always 100.

Component a)

The polyamides to be used as component a) are preferably amorphous or semicrystalline polyamides. Particular preference is given to semicrystalline polyamides having a melting point of at least 180° C. or amorphous polyamides having a glass transition temperature of at least 150° C.

According to DE 10 2011 084 519 A1, semicrystalline polyamides have an enthalpy of fusion of from 4 to 25 J/g, measured by the DSC method in accordance with ISO 11357 in the 2nd heating and integration of the melt peak. In contrast, amorphous polyamides have an enthalpy of fusion of less than 4 J/g, measured by the DSC method in accordance with ISO 11357 in the 2nd heating and integration of the melt peak.

In a preferred embodiment, a blend of different polyamides is also used as component a).

Preference is given to using aliphatic polyamide, particularly preferably polyamide 6 (PA 6), polyamide 4.6 (PA 46) or polyamide 66 (PA 66), or semiaromatic polyamide, particularly preferably PA 6T/6 and PA 6T/66, or a copolyamide of PA 6 or PA 66 as component a). Very particular preference is given to using PA 6 or PA 66. PA 6 is especially preferably used.

The nomenclature of the polyamides used in the context of the present application corresponds to the international standard, the first number(s) denoting the number of carbon atoms in the starting diamine and the last number(s) denoting the number of carbon atoms in the dicarboxylic acid. If only one number is stated, as in the case of PA6, this means that the starting material was an α,ω-aminocarboxylic acid or the lactam derived therefrom, i.e. ε-caprolactam in the case of PA 6; for further information, reference is made to H. Domininghaus, Die Kunststoffe und ihre Eigenschaften, pages 272 ff., VDI-Verlag, 1976.

The polyamide to be used as component a) preferably has a viscosity number determined in a 0.5% strength by weight solution in 96% strength by weight sulfuric acid at 25° C. in accordance with ISO 307 in the range from 80 to 180 ml/g, particularly preferably in the range from 90 to 170 ml/g, very particularly preferably in the range from 95 to 160 ml/g.

In a particularly preferred embodiment, the polyamide 6 to be used as component a) has a viscosity number determined in a 0.5% strength by weight solution in 96% strength by weight sulfuric acid at 25° C. in accordance with ISO 307 in the range from 100 to 135 ml/g.

The viscosity number is the characteristic parameter for the average molar mass (molecular chain length) and is reported as the K value. The K value is calculated from the viscosity ratio according to an equation described by Fikentscher in 1929 (see: http://de.wikipedia.org/wiki/K-Wert_nach_Fikentscher). The latter is the experimental basis for calculation of viscosity numbers. The rating of a group of products with regard to characterization of the molar mass is thus the same according to the K value and viscosity number. Conversion tables for the viscosity number and the K value may be found in EN ISO 1628-2.

The polyamides to be used as component a) in the compositions of the invention can be produced by various methods and be synthesized from different building blocks. Many methods are known for producing polyamides, with different monomer building blocks and also various chain transfer agents for setting a desired molecular weight or else monomers having reactive groups for later intended after-treatments being used depending on the desired end product.

The industrially relevant processes for producing the polyamides to be used according to the invention as component a) usually proceed via polycondensation in the melt. For the purposes of the present invention, the hydrolytic polymerization of lactams is also considered to be polycondensation.

Polyamides which are preferably to be used according to the invention as component a) are those which are prepared from diamines and dicarboxylic acids and/or lactams having at least 5 ring atoms or corresponding amino acids. Preferred starting materials are aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, hexamethylenediamine, 2-methylpentane-1,5-diamine, 1,9-nonanediamine, 2,2,4- and 2,4,4-trimethylhexamethylenediamine, the isomers of diaminodicyclohexylmethane, diaminodicyclohexylpropane, bisaminomethylcyclohexane, phenylenediamine, xylylenediamine, amino carboxylic acids, in particular aminocaproic acid, or the corresponding lactams. Copolyamides of a plurality of the monomers mentioned are included.

Particularly preferred polyamides to be used according to the invention as component a) are prepared from caprolactam, very particularly preferably from ε-caprolactam.

Furthermore, most compounds which are based PA 6, PA 66 and other compounds which are based on aliphatic or/and aromatic polyamides or copolyamides and in which from 3 to 11 methylene groups per polyamide group are particularly preferably present in the polymer chain.

Component b)

The components boron nitride and aluminum oxide are, in a preferred embodiment, used in the form of fine needles, platelets, spheres or irregularly shaped particles. Preferred average particle sizes of the boron nitride and of the aluminum oxide are in the range from 0.1 to 300 μm, particularly preferably in the range from 0.5 to 100 μm. The thermal conductivity of the boron nitride and of the aluminum oxide is preferably in the range from 10 to 400 W/mK, particularly preferably in the range from 30 to 250 W/mK. A suitable example of aluminum oxide is Martoxid® MPS-2 [CAS No. 1344-28-1] from Martinswerk GmbH, Bergheim, Germany. Boron nitrides [CAS No. 10043-11-5] to be used according to the invention are obtainable, for example, as Polartherm® PT from Momentive Performance Materials Inc., Strongsville, USA.

For the purposes of the present invention, triclinic pinacoidal aluminum silicate is used as component b). The mineral kyanite [CAS No. 1302-76-7] to be used as triclinic pinacoidal aluminum silicate for the purposes of the present invention is an aluminum silicate which crystallizes in the triclinic crystal system and has the chemical composition Al₂[O SiO₄]. Kyanite can be contaminated with iron and/or chromium compounds. For the purposes of the invention, preference is given to using triclinic pinacoidal aluminum silicate or kyanite containing less than 1% by weight, particularly preferably less than 0.5% by weight, of impurities.

The Al₂[O SiO₄] or kyanite is preferably used as powder. Preferred kyanite powders have an average particle size d₅₀ of not more than 500 μm, preferably an average particle size in the range from 0.1 to 250 μm, particularly preferably in the range from 0.5 to 150 μm, very particularly preferably in the range from 0.5 to 70 μm, as a result of which fine dispersion in the molding compositions obtainable from the compositions of the invention and in the products to be produced therefrom is ensured.

In the case of nonspherical particles, the size is, for the purposes of the present invention, determined via the equivalent spherical diameter (Stokes diameter). All these d50 and d95 diameter measurements are carried out using a “Sédigraph” (trademark) apparatus by gravitational sedimentation in accordance with the standard AFNOR X11-683.

The Al₂[O SiO₄] particles or kyanite particles to be used according to the invention as component b) can be present in different forms which are described by the aspect ratio.

Preference is given to using kyanite particles having an aspect ratio in the range from 1 to 100, particularly preferably in the range from 1 to 30, very particularly preferably in the range from 1 to 10 mm.

The Al₂[O SiO₄] particles or kyanite particles to be used according to the invention as component b) can be used with and/or without surface modification. The term surface modification refers to organic coupling agents which are intended to improve bonding of the particles to the thermoplastic matrix. Aminosilanes or epoxysilanes are preferably used for surface modification. In a particularly preferred embodiment, the Al₂[O SiO₄] particles or kyanite particles to be used according to the invention are used without surface modification. A supplier of kyanite is, for example, Quarzwerke GmbH, Frechen, Germany, which markets kyanite as Al₂[O SiO₄] under the trade name Silatherm®.

The triclinic pinacoidal aluminum silicate, kyanite, to be used as component b) is, in a preferred embodiment, used as a mixture with at least one of the components boron nitride or aluminum oxide.

The invention in this case preferably provides compositions containing at least one polyamide, triclinic pinacoidal aluminum silicate and boron nitride.

The invention in this case also preferably provides compositions containing at least one polyamide, triclinic pinacoidal aluminum silicate and aluminum oxide.

However, the invention in this case also preferably provides compositions containing at least polyamide, triclinic pinacoidal aluminum silicate, boron nitride and aluminum oxide.

The present invention preferably provides compositions containing

a) from 20 to 90% by weight, preferably from 30 to 70% by weight, of at least one polyamide and

b) from 10 to 80% by weight, preferably from 15 to 75% by weight, particularly preferably from 30 to 70% by weight, of triclinic pinacoidal aluminum silicate and boron nitride.

In addition, the present invention preferably provides compositions containing

a) from 20 to 90% by weight, preferably from 30 to 70% by weight, of at least one polyamide and

b) from 10 to 80% by weight, preferably from 15 to 75% by weight, particularly preferably from 30 to 70% by weight, of triclinic pinacoidal aluminum silicate and aluminum oxide.

The present invention also preferably provides compositions containing

a) from 20 to 90% by weight, preferably from 30 to 70% by weight, of at least one polyamide and

b) from 10 to 80% by weight, preferably from 15 to 75% by weight, particularly preferably from 30 to 70% by weight, of triclinic pinacoidal aluminum silicate, boron nitride and aluminum oxide.

Component c)

According to “http://de.wikipedia.org/wiki/Faser-Kunststoff-Verbund”, a distinction is made between chopped fibers, also known as short fibers, having a length in the range from 0.1 to 1 mm, long fibers having a length in the range from 1 to 50 mm and continuous fibers having a length L>50 mm. Short fibers are used in injection molding technology and can be processed directly by means of an extruder. Long fibers can likewise still be processed in extruders. They are widely used in fiber spraying. Long fibers are frequently added to thermosets as a filler. Continuous fibers are used in the form of rovings or fabric in fiber-reinforced plastics. Products comprising continuous fibers achieve the highest stiffness and strength values. The fiber length in the glass flour is in the range from 70 to 200 μm.

According to the invention, it is possible to use short glass fibers, long glass fibers or continuous glass fibers. Preference is given to using long glass fibers or continuous glass fibers, particularly preferably long glass fibers. However, the glass fibers can also be used as milled glass fibers.

The glass fibers preferably have an average fiber diameter in the range from 7 to 18 μm, particularly preferably in the range from 9 to 15 μm, where the average fiber diameter of an individual fiber is carried out semiautomatically by length and thickness measurement with the aid of scanning electron micrographs (SEM) using digitization and computer-aided data recording.

The glass fibers to be used as component c) are preferably provided with a suitable size system or a bonding agent or bonding agent system, particularly preferably one based on silane.

Very particularly preferred silane-based bonding agents are silane compounds of the general formula (I)

(X—(CH₂)_{q})ₖ—Si—(O—CrH₂ᵣ₊₁)₄₋ₖ (I)

where the substituents are defined as follows:

X NH₂—, HO—,

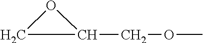

q: an integer from 2 to 10, preferably from 3 to 4,

r: an integer from 1 to 5, preferably from 1 to 2,

k: an integer from 1 to 3, preferably 1.

Especially preferred bonding agents are silane compounds from the group consisting of aminopropyltrimethoxysilane, aminobutyltrimethoxysilane, aminopropyltriethoxysilane, aminobutyltriethoxysilane and the corresponding silanes containing a glycidyl group as the X substituent.

For the modification of the glass fibers to be used as component c), the silane compounds are preferably used in amounts in the range from 0.05% to 2% by weight, particularly preferably in the range from 0.25% to 1.5% by weight and in particular in the range from 0.5% to 1% by weight, based on the amount of glass fibers, for surface coating.

The glass fibers can, due to processing/compounding to form the molding composition or the product to be produced therefrom, have a smaller d97 or d50 value in the molding composition or in the product than that of the glass fibers originally used. The glass fibers can, due to processing to give the molding composition (compounding) or shaped body (injection molding or extrusion) have shorter length distributions in the molding composition or in the shaped body than as originally used.

Component d)

Preferred thermal stabilizers to be used as component d) are selected from the group consisting of the sterically hindered phenols, which are compounds which have a phenolic structure and have at least one bulky group on the phenolic ring. Particularly preferred sterically hindered phenols are compounds of the formula (II),

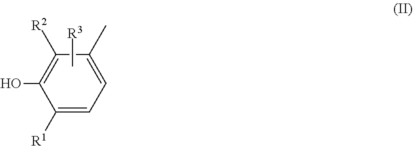

where R¹ and R² are each an alkyl group, a substituted alkyl group or a substituted triazole group, where the radicals R¹ and R² can be identical or different and R³ is an alkyl group, a substituted alkyl group, an alkoxy group or a substituted amino group.

According to “http://de.wikipedia.org/wiki/Sterische_Hinderung”, steric hindrance in organic chemistry describes the influence of the spatial extension of a molecule on the course of a reaction. The term was first coined by Victor Meyer in 1894 for the observation that some reactions proceed only very slowly or not at all when large and bulky groups are present in the vicinity of the reacting atoms. A known example of the influence of steric hindrance or a bulky group is the presence of very bulky tert-butyl groups.

Very particularly preferred thermal stabilizers of the formula (II) are described as antioxidants, for example in DE-A 27 02 661, the contents of which are fully incorporated by reference in the present patent application.

A further group of preferred sterically hindered phenols is derived from substituted benzenecarboxylic acids, in particular from substituted benzenepropionic acids. Particularly preferred compounds from this class are compounds of the formula (III)

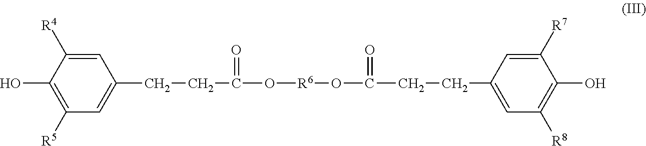

where R⁴, R⁵, R⁷ and R⁸ are, independently of one another, C₁-C₈-alkyl groups which may be substituted and of which at least one is a bulky group and R⁶ is a divalent aliphatic radical which has from 1 to 10 carbon atoms and can also have C—O bonds in the main chain.

Particularly preferred compounds of the formula (III) are compounds of the formulae (IV), (V) and (VI).

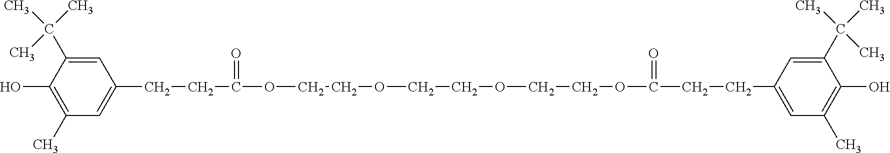 [SMILES: Cc1cc(CCC(=O)OCCOCCOCCOC(=O)CCc2cc(C)c(O)c(C(C)(C)C)c2)cc(C(C)(C)C)c1O]

(IV) (Irganox® 245 from BASF SE)

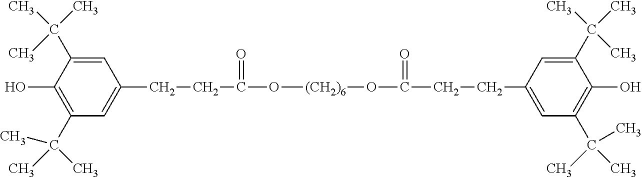

(V) (Irganox 259 from BASF SE)

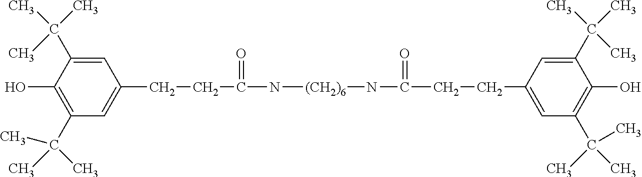

(VI) (Irganox® 1098 from BASF SE)

Very particularly preferred thermal stabilizers are selected from the group consisting of 2,2′-methylenebis(4-methyl-6-tert-butylphenol), 1,6-hexanediyl bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Especially preferred thermal stabilizers are selected from the group consisting of 2,2′-methylenebis(4-methyl-6-tert-butylphenol), 1,6-hexanediyl bis[3-(3,5-di-tert-butyl-4-hydroxyphenyl)propionate] (Irganox® 259), pentaerythrityl tetrakis[3-(3,5-di-tert-butyl-4-hydroxyphenyl)propionate] and N,N′-hexamethylenebis-3,5-di-tert-butyl-4-hydroxyhydrocinnamide (Irganox® 1098) and the above-described Irganox® 245 from BASF SE, Ludwigshafen, Germany.

Very particular preference is given according to the invention to using N,N′-hexamethylene-bis-3,5-di-tert-butyl-4-hydroxyhydrocinnamide, [CAS No. 23128-74-7], which is obtainable as Irganox® 1098 from BASF SE, Ludwigshafen, Germany, as thermal stabilizer.

Component e)

Preferred flame retardants e) are commercial organic halogen compounds with synergists or commercial organic nitrogen compounds or organic/inorganic phosphorus compounds, which are used individually or in admixture with one another, and also mineral flame retardant additives, preferably magnesium hydroxide or Ca—Mg carbonate hydrates (e.g. DE-A 4 236 122).

As organic halogen compounds, in particular brominated and chlorinated compounds, preference is given to ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers.

Suitable organic/inorganic phosphorus compounds are the phosphorus compounds described in WO-A 98/17720, preferably red phosphorus, metal phosphinates, in particular aluminum phosphinate or zinc phosphinate, metal phosphonates, especially aluminum phosphonate, calcium phosphonate or zinc phosphonate, derivatives of the 9,10-dihydro-9-oxa-10-phosphaphenanthrene 10-oxides (DOPO derivatives), triphenyl phosphate (TPP), resorcinol bis(diphenyl phosphate) (RDP), including oligomers, and bisphenol A bis(diphenyl phosphate) (BDP) including oligomers, and also zinc bis(diethylphosphinate), aluminum tris(diethylphosphinate), melamine phosphate, melamine pyrophosphate, melamine polyphosphate, melamine poly(aluminum phosphate), melamine poly(zinc phosphate) or phenoxyphosphazene oligomers and mixtures thereof.

Possible organic nitrogen compounds are, in particular, melamine or melamine cyanurate, reaction products of trichlorotriazine, piperazine and morpholine as per CAS-No. 1078142-02-5 (e.g. MCA PPM triazine HF from MCA Technologies GmbH, Biel-Benken, Switzerland).

As synergists, preference is given to antimony compounds, in particular antimony trioxide or antimony pentoxide, zinc compounds, tin compounds, in particular zinc stannate, or various borates, in particular zinc borates.

Carbon formers and tetrafluoroethylene polymers can also be added to the flame retardant.

Among the halogen-containing flame retardants, particular preference is given to using brominated polystyrenes such as Firemaster® PBS64 (Great Lakes, West Lafayette, USA) or brominated phenylene ethers, in each case very particularly preferably in combination with antimony trioxide and/or zinc stannates as synergists. Among the halogen-free flame retardants, particular preference is given to using aluminum tris(diethylphosphinate) in combination with melamine polyphosphate (e.g. Melapur® 200/70 from BASF SE, Ludwigshafen, Germany) and zinc borate (e.g. Firebrake® 500 or Firebrake® ZB from RioTinto Minerals, Greenwood Village, USA) or aluminum tris(diethylphosphinate) in combination with aluminum phosphonate and/or aluminum phosphonate hydrate.

Especial preference is given to using aluminum tris(diethylphosphinate) (e.g. Exolit® OP1230 from Clariant International Ltd., Muttenz, Switzerland) [CAS No. 225789-38-8] in combination with melamine polyphosphate [CAS No. 41583-09-9 or CAS No. 255-449-7] (Melapur® 200/70) and zinc borate [CAS No. 51201-70-8] (Firebrake® 500) as flame retardant.

Component f)

Conventional additives of the component f) are preferably stabilizers, mold release agents, UV stabilizers, gamma-ray stabilizers, laser absorbers, antistatics, fluidizers, elastomer modifiers, emulsifiers, nucleating agents, acids scavengers, plasticizers, lubricants, dyes, laser marking additives or pigments. The additives can be used either alone or in admixture or in the form of masterbatches.

As stabilizers, preference is given to using hydroquinones, aromatic secondary amines, in particular diphenylamines, substituted resorcinols, salicylates, benzotriazoles and benzophenones, and also various substituted representatives of these groups or mixtures thereof.

Preferred mold release agents are selected from the group consisting of ester waxes, pentaerythritol tetrastearate (PETS), long-chain fatty acids, fatty acid salts, amide derivatives, montan waxes, low molecular weight polyethylene and polypropylene waxes and ethylene homopolymer waxes.

Preferred long-chain fatty acids are stearic acid or behenic acid.

Preferred fatty acid salts are Ca or Zn stearate.

A preferred amide derivative is ethylenebisstearylamide.

Preferred montan waxes are mixtures of straight-chain saturated carboxylic acids having chain lengths of from 28 to 32 carbon atoms.

As pigments or dyes, preference is given to using zinc sulfide, titanium dioxide, ultramarine blue, iron oxide, carbon black, phthalocyanines, quinacridones, perylenes, nigrosin and anthraquinones. The titanium dioxide which is preferably to be used as pigment, preferably has an average particle size in the range from 90 nm to 2000 nm. Possible titanium dioxides which are preferably to be used according to the invention as pigment are titanium dioxide pigments whose parent oxides can have been prepared by the sulfate (SP) or chloride (CP) process and have the anatase and/or rutile structure, preferably the rutile structure. The parent oxide does not have to be stabilized, but a specific stabilization is preferred: in the CP parent oxide by an Al doping of 0.3-3.0% by weight (calculated as Al₂O₃) and an oxygen excess in the gas phase during the oxidation of the titanium tetrachloride to form titanium dioxide of at least 2%; in the case of the SP parent oxide by doping with, for example, Al, Sb, Nb or Zn. Particular preference is given to “slight” stabilization with Al, or in the case of larger amounts of Al dopant, compensation with antimony. It is known that when using titanium dioxide as white pigment in paints and coatings, plastics materials etc. unwanted photocatalytic reactions caused by UV absorption lead to decomposition of the pigmented material. This involves absorption of light in the near ultraviolet range by titanium dioxide pigments, forming electron-hole pairs which produce highly reactive free radicals on the titanium dioxide surface. The free radicals formed result in binder degradation in organic media. Preference is given in accordance with the invention to lowering the photoactivity of the titanium dioxide by inorganic aftertreatment thereof, particularly preferably with oxides of Si and/or Al and/or Zr and/or through the use of Sn compounds.

The surface of pigmentary titanium dioxide is covered preferably with amorphous precipitants of oxide hydrates of the compounds SiO₂ and/or Al₂O₃ and/or zirconium oxide. The Al₂O₃ shell facilitates pigment dispersion in the polymer matrix and the SiO₂ shell impedes charge exchange at the pigment surface and hence prevents polymer degradation.

In accordance with the invention the titanium dioxide is preferably provided with hydrophilic and/or hydrophobic organic coatings, in particular with siloxanes or polyalcohols.

Titanium dioxide which can be used as pigment with particular preference in accordance with the invention has an average particle size in the range from 90 nm to 2000 nm, preferably in the range from 200 nm to 800 nm. Commercially available products are, for example, Kronos® 2230, Kronos® 2225 and Kronos® vlp7000 from Kronos, Dallas, USA.

Nucleating agents used are preferably talc, sodium phenylphosphinate or calcium phenylphosphinate, aluminium oxide or silicon dioxide, particular preference being given to talc. Talc is a magnesium silicate hydrate in pulverized form, having the chemical composition Mg₃[Si₄O₁₀(OH)₂], ([CAS No. 14807-96-6]).

Acid scavengers used are preferably hydrotalcite, chalk, boehmite or zinc stannate.

Plasticizers used are preferably dioctyl phthalate, dibenzyl phthalate, butyl benzyl phthalate, hydrocarbon oils or N-(n-butyl)benzenesulfonamide.

The additive to be used as elastomer modifier is preferably one or more graft polymer(s) E of
E.1 5 to 95% by weight, preferably 30 to 90% by weight, of at least one vinyl monomer,
E.2 95 to 5% by weight, preferably from 70 to 10% by weight, of one or more graft bases having glass transition temperatures of <10° C., preferably <0° C., more preferably <−20° C.

The graft base E.2 generally has a medium particle size (d₅₀) of 0.05 to 10 μm, preferably 0.1 to 5 μm, more preferably from 0.2 to 1 μm.

Monomers E.1 are preferably mixtures of
E.1.1 50 to 99% by weight of vinylaromatics and/or ring-substituted vinylaromatics, preferably styrene, α-methylstyrene, p-methylstyrene, p-chlorostyrene and/or (C₁-C₈)-alkyl methacrylates, preferably methyl methacrylate, ethyl methacrylate, and
E.1.2 1 to 50% by weight of vinyl cyanides, preferably unsaturated nitriles such as acrylonitrile and methacrylonitrile, and/or (C₁-C₈)-alkyl (meth)acrylates, preferably methyl methacrylate, n-butyl acrylate, t-butyl acrylate, and/or derivatives, preferably anhydrides and imides, of unsaturated carboxylic acids, preferably maleic anhydride and N-phenylmaleimide.

Preferred monomers E.1.1 are selected from at least one of the monomers styrene, α-methylstyrene and methyl methacrylate; preferred monomers E.1.2 are selected from at least one of the monomers acrylonitrile, maleic anhydride and methyl methacrylate.

Particularly preferred monomers are E.1.1 styrene and E.1.2 acrylonitrile.

Graft bases E.2 suitable for the graft polymers for use in the elastomer modifiers are preferably diene rubbers, EP(D)M rubbers, i.e. those based on ethylene/propylene, and optionally diene, acrylate, polyurethane, silicone, chloroprene and ethylene-vinyl acetate rubbers.

Preferred graft bases E.2 are diene rubbers (in particular based on butadiene, isoprene etc.) or mixtures of diene rubbers or copolymers of diene rubbers or mixtures thereof with further copolymerizable monomers (for example as per E.1.1 and E.1.2), with the proviso that the glass transition temperature of component E.2 is <10° C., preferably <0° C., more preferably <−10° C.

A particularly preferred graft base E.2 is pure polybutadiene rubber.

Particularly preferred polymers E are ABS polymers (emulsion, bulk and suspension ABS), as described, for example, in DE-A 2 035 390 (=U.S. Pat. No. 3,644,574) or in DE-A 2 248 242 (=GB-A 1 409 275) or in Ullmann, Enzyklopädie der Technischen Chemie [Encyclopedia of Industrial Chemistry], vol. 19 (1980), p. 280 ff.

The gel content of the graft base E.2 is at least 30% by weight, preferably at least 40% by weight (measured in toluene). ABS means acrylonitrile-butadiene-styrene copolymer with CAS number 9003-56-9 and is a synthetic terpolymer formed from the three different monomer types acrylonitrile, 1,3-butadiene and styrene. It is one of the amorphous thermoplastics. The ratios may vary may vary from 15-35% acrylonitrile, 5-30% butadiene and 40-60% styrene.

The elastomer modifiers or graft copolymers E are prepared by free-radical polymerization, for example by emulsion, suspension, solution or bulk polymerization, preferably by emulsion or bulk polymerization. Particularly suitable graft rubbers are also ABS polymers, which are prepared by redox initiation using an initiator system composed of organic hydroperoxide and ascorbic acid according to U.S. Pat. No. 4,937,285.

Since, as is well known, the graft monomers are not necessarily grafted completely onto the graft base in the grafting reaction, according to the invention, graft polymers E are also understood to mean those products which are obtained through (co)polymerization of the graft monomers in the presence of the graft base and occur in the workup as well.

Suitable acrylate rubbers are based on graft bases E.2, which are preferably polymers of alkyl acrylates, optionally with up to 40% by weight, based on E.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, especially preferably chloroethyl acrylate, and mixtures of these monomers.

Crosslinking may be achieved by copolymerizing monomers comprising more than one polymerizable double bond. Preferred examples of crosslinking monomers are esters of unsaturated monocarboxylic acids having from 3 to 8 carbon atoms and unsaturated monohydric alcohols having 3 to 12 carbon atoms or of saturated polyols having 2 to 4 OH groups and 2 to 20 carbon atoms, for example ethylene glycol dimethacrylate, allyl methacrylate; polyunsaturated heterocyclic compounds, for example trivinyl cyanurate and triallyl cyanurate; polyfunctional vinyl compounds such as di- and vinylbenzenes but also triallyl phosphate and diallyl phthalate.

Preferred crosslinking monomers are allyl methacrylate, ethylene glycol dimethacrylate, diallyl phthalate and heterocyclic compounds comprising at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably from 0.02 to 5%, especially 0.05 to 2% by weight, based on the graft base E.2.

In the case of cyclic crosslinking monomers having at least 3 ethylenically unsaturated groups, it is advantageous to restrict the amount to below 1% by weight of the graft base E.2.

Preferred “other” polymerizable, ethylenically unsaturated monomers which, alongside the acrylic esters, may optionally serve for preparation of the graft base E.2 are, for example, acrylonitrile, styrene, α-methylstyrene, acrylamide, vinyl C₁-C₆-alkyl ethers, methyl methacrylate, butadiene. Preferred acrylate rubbers as graft base E.2 are emulsion polymers having a gel content of at least 60% by weight.

Further suitable graft bases according to E.2 are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Irrespective of component c), additional fillers and/or reinforcing materials may be present as additives in the inventive compositions.

Preference is also given to using a mixture of two or more different fillers and/or reinforcers, especially based on talc, mica, silicate, quartz, titanium dioxide, wollastonite, kaolin, amorphous silicas, magnesium carbonate, chalk, feldspar, barium sulfate, glass beads and/or fibrous fillers and/or reinforcing materials based on carbon fibers.

Preference is given to using mineral particulate fillers based on mica, silicate, quartz, wollastonite, kaolin, amorphous silicas, magnesium carbonate, chalk, feldspar or barium sulphate. Particular preference is given in accordance with the invention to using mineral particulate fillers based on wollastonite or kaolin.

Particular preference is additionally also given to using acicular mineral fillers as an additive. In accordance with the invention the term acicular mineral fillers is to be understood as meaning a mineral filler having a highly pronounced acicular character. Examples include in particular acicular wollastonites. The mineral preferably has a length to diameter ratio in the range from 2:1 to 35:1, particularly preferably in the range from 3:1 to 19:1, most preferably in the range from 4:1 to 12:1. The median particle size of the inventive acicular minerals is preferably less than 20 μm, more preferably less than 15 μm, especially preferably less than 10 μm, determined with a CILAS GRANULOMETER.

As already described above for component b), in a preferred use form, the filler and/or reinforcer for use as component f) may also have been surface-modified, more preferably with a bonding agent or bonding agent system, especially preferably based on silane. However, the pretreatment is not absolutely necessary.

For the modification of the fillers for use as additive, the silane compounds are generally used in amounts of 0.05 to 2% by weight, preferably 0.25 to 1.5% by weight and especially 0.5 to 1% by weight, based on the mineral filler, for surface coating.

The particulate fillers to be used as component f) can, due to the processing, preferably during compounding, to give the molding composition or in later processing to give the shaped body/product, have a smaller d97 or d50 value in the molding composition or in the shaped body/product than the fillers originally used.

Laser absorbers are, according to Kunststoffe 8, 2008, 119-121, laser light absorbers, preferably for writing on plastics products. Preferred laser absorbers are selected from the group consisting of antimony trioxide, tin oxide, tin orthophosphate, barium titanate, aluminum oxide, copper hydroxyphosphate, copper orthophosphate, potassium copper diphosphate, copper hydroxide, antimony-tin oxide, bismuth trioxide and anthraquinone. Particular preference is given to antimony trioxide and antimony-tin oxide. Very particular preference is given to antimony trioxide.

The laser absorber, in particular the antimony trioxide, can be used directly as powder or in the form of masterbatches. Preferred masterbatches are those based on polyamide or those based on polybutylene terephthalate, polyethylene, polypropylene, polyethylene-polypropylene copolymer, maleic anhydride-grafted polyethylene and/or maleic anhydride-grafted polypropylene, where the polymers for the antimony trioxide masterbatch can be used either individually or in admixture. Very particular preference is given to using antimony trioxide in the form of a polyamide 6-based masterbatch.

The laser absorber can be used individually or as a mixture of a plurality of laser absorbers.

Laser absorbers can absorb laser light of a particular wavelength. In practice, this wavelength is in the range from 157 nm to 10.6 μm. Examples of lasers of these wavelengths are described in WO2009/003976 A1. Preference is given to using Nd:YAG lasers by means of which it is possible to achieve wavelengths of 1064, 532, 355 and 266 nm, and CO₂ lasers.

The present invention particularly preferably provides compositions containing PA 6, triclinic aluminum silicate, ethylenebis(stearylamide) [=CAS-No. 110-30-5] and Mg₃[Si₄O₁₀(OH)₂].

Process

Molding compositions to be used for injection molding or for extrusion are obtained by mixing or compounding the components a) and b) and optionally c) and/or d) and/or e) in the percentages by weight indicated in at least one mixing apparatus, preferably at least one extruder.

The mixed composition is then discharged as molding composition through at least one mixing apparatus outlet, preferably at least one extruder outlet, to give a strand which is cooled to make it pelletizable and is pelletized. Pelletization is preferably followed by a drying step.

The mixing/compounding of the components listed above in the percentages by weight indicated is preferably carried out at temperatures in the range from 240 to 300° C. in the melt, preferably in an extruder, particularly preferably in a twin-screw extruder.

In a preferred embodiment, the pellets obtained in the extruder, which comprise the composition according to the invention, are dried at 80° C. in a dry air dryer or vacuum drying oven for about 2-6 hours before being subjected to injection molding or an extrusion process in order to produce products.

The present invention therefore also provides a process for producing products which meet relatively high flame resistance requirements, preferably products for the electrical or electronics industry, particularly preferably electronic or electric assemblies and components, by using compositions according to the invention as molding composition in injection molding or in extrusion, preferably in injection molding.

Processes according to the invention for producing products by extrusion or injection molding preferably operate at melt temperatures in the range from 230 to 330° C., particularly preferably in the range from 240 to 300° C., very particularly preferably in the range from 250 to 280° C., and optionally additionally at pressures of not more than 2500 bar, preferably at pressures of not more than 2000 bar, particularly preferably at pressures of not more than 1500 bar and very particularly preferably at pressures of not more than 750 bar.

In sequential coextrusion, one variant of extrusion, two different materials are extruded successively in an alternating sequence. In this way, a preform having a different material composition section by section in the extrusion direction is formed. It is possible to provide particular article sections having specifically required properties by means of appropriate material selection, for example for articles having flexible ends and a hard middle section or integrated flexible bellows regions (Thielen, Hartwig, Gust, “Blasformen von Kunststoffhohlkörpern”, Carl Hanser Verlag, Munich 2006, pages 127-129).

The process of injection molding is characterized in that the raw material based on a composition according to the invention, preferably in pellet form, is melted (plasticized) in a heated cylindrical hollow space and injected as injection molding composition under pressure into a temperature-controlled hollow space. After cooling (solidification) of the composition, the injection-molded part is removed from the mold.

A distinction is made between the working steps:

1. plasticization/melting

2. injection phase (filling operation)

3. hold pressure phase (because of thermal contraction during crystallization)

4. demolding.

An injection molding machine comprises a closure unit, the injection unit, the drive and the control system. The closure unit includes fixed and movable platens for the tool, an end platen, and tie bars and the drive for the movable tool platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pellets containing at least the components a) and b). The problem of melt backflow inside the screw (leakage flow) is solved by nonreturn valves.

In the injection molding tool, the inflowing melt is then detached, cooled and the product to be made is thus produced. Two halves of a tool are always required for this purpose. In injection molding, a distinction is made between the following functional systems:
sprue system
shaping inserts
venting
machine mounting and force absorption
demolding system and motion transmission
temperature control

In contrast to injection molding, extrusion uses a continuous shaped polymer strand containing the composition according to the invention in an extruder, where the extruder is a machine for producing shaped thermoplastic parts. A distinction is made between the following:
single-screw extruder and twin-screw extruder and the respective subassemblies
conventional single-screw extruder, conveying single-screw extruder,
contrarotating twin-screw extruder and corotating twin-screw extruder.

Extrusion plants consist of extruder, tool, downstream equipment, extrusion blow molds. Extrusion plants for producing profiles consist of extruder, profile tool, calibration, cooling section, caterpillar and roller offtake, parting device and chipping chute.

The present invention therefore also provides products obtainable by extrusion or injection molding of the molding compositions of the invention.

### EXAMPLES

The components indicated in table 1 were mixed in a ZSK 26 Compounder twin-screw extruder from Coperion Werner & Pfleiderer (Stuttgart, Germany) at a temperature of about 280° C., discharged as strand into a water bath, cooled until pelletizable and pelletized. The pellets were dried to constant weight at 70° C. in a vacuum drying oven.

The pellets were subsequently processed on an Arburg A470 injection molding machine at melt temperatures in the range from 270 to 290° C. and tool temperatures in the range from 80 to 100° C. to give test specimens having a size of 80 mm×10 mm×4 mm and round plates having a diameter of 80 mm and a thickness of 0.75 mm, 1.5 mm or 3 mm.

The mechanical properties of the products produced from the compositions according to the invention were determined in a bending test in accordance with ISO 178 and in the IZOD impact test in accordance with ISO180/1U.

The glow wire resistance was determined by means of glow wire test GWFI (Glow Wire Flammability Index) in accordance with IEC 60695-2-12.

Good mechanical properties for the purposes of the present invention are indicated by, in particular, high values of the flexutral strength of products to be produced. The flexural strength in applied mechanics is a value of a flexural stress in a component subjected to bending, which when exceeded leads to failure by fracture of the component. It describes the resistance that a workpiece offers to deflection or fracture. In the short-term bending test in accordance with ISO 178, bar-shaped test specimens, preferably having the dimensions 80 mm×10 mm×4 mm, are placed at the ends on two supports and loaded in the middle by means of a bending punch (Bodo Carlowitz: Tabellarische Übersicht über die Prüfung von Kunststoffen, 6th edition, Giesel-Verlag für Publizität, 1992, pp. 16-17).

In accordance with “http://de.wikipedia.org/wiki/Biegeversuch”, the flexural modulus is determined in a 3-point bending test by positioning a test specimen on two supports and loading it in the center with a test punch. This is probably the most commonly used form of bending test. The flexural modulus is then calculated in the case of a flat sample as follows:

$$E = \frac{{l}_{v}^{3} ( {X}_{H} - {X}_{L} )}{4 {D}_{L} {ba}^{3}}$$

where E=flexural modulus in kN/mm²; Iᵥ=support width in mm; X_{H}=end of flexural modulus determination in kN; X_{L}=start of flexural modulus determination in kN; D_{L}=deflection in mm between X_{H} and X_{L}; b=sample width in mm; a=sample thickness in mm.

The edge fiber elongation can be determined from a thermal property of a material, viz. the heat distortion resistance. Heat distortion resistance is a measure of the thermal durability of plastics. Owing to the fact that they have viscoelastic behavior, there is no strictly defined upper use temperature for plastics; instead, a substitute parameter is determined under defined load. Two standardized methods are available for this purpose.

This method described in DIN EN ISO 75-1,-2,-3 (predecessor: DIN 53461) for determining the heat distortion resistance temperature (HDT=heat deflection temperature) uses standard test specimens which have a rectangular cross section and are preferably subjected on a flat side to three-point bending under constant load. Depending on the test specimen height, an edge fiber strain σ_{f} of 1.80 (Method A), 0.45 (Method B) or 8.00 N/mm² (Method C) is applied by using weights or/and springs to apply a force

$$F = \frac{2 {σ}_{f} {bh}^{2}}{3 L}$$

b: Specimen width
h: Specimen height
L: Support spacing

The loaded specimens are subsequently subjected to heating at a constant heating rate of 120 K/h (or 50 K/h). If the deflection of the specimen reaches an edge fiber elongation of 0.2%, the corresponding temperature is the heat distortion resistance temperature (heat deflection temperature or heat distortion temperature) HDT. In the case of the method HDT-A which is frequently used, thus also for the purposes of the present invention, the applied flexural stress is 1.8 MPa.

The impact toughness in accordance with ISO 180/1U is a measure of the ability of a material to absorb impact energy and percussion energy without breaking. Here, many factors determine the impact strength of a component:
wall thickness
shape and size of the component
temperature
impact speed

The impact toughness is measured by means of an impact hammer. The impact toughness is calculated as the ratio of impact energy and test specimen cross section (unit of measurement: kJ/m²). There are various measurement methods, viz. the Charpy or IZOD methods. In the IZOD method used for the purposes of the present invention, the test specimen is clamped upright and only on one side.

The evaluation of the thermal stability, which is an important factor in determining the processing window, was carried out by means of thermogravimetric analysis (TGA). For this purpose, the specimen was heated in air in a TGA instrument (Netzsch TG209 F1 Iris) at a heating rate of 20.0 K/min and the change in mass over the temperature was recorded. The temperature at which a cumulated decrease in mass of 2% occurred was defined as the temperature T(Z) at which the thermal stability is no longer satisfactory.

Materials Used:
Component a/1: Polyamide 6 (Durethan® B29, from Lanxess Deutschland GmbH, Cologne, Germany)
Component b/1: Kyanite, e.g. Silatherm®-T 1360-400 AST from Quarzwerke GmbH, Frechen, Germany
Component b/2: Magnesium hydroxide, e.g. Magnifin® 5HIV, Martinswerk GmbH, Bergheim, Germany

Component f): Further additives customarily used in polyamides, for example mold release agents (in particular ethylenebis(stearylamide), [CAS-No. 110-30-5], nucleating agents (e.g. based on talc). Type and amount of the additives referred to collectively as component f) correspond in type and amount for the examples and comparative examples.

The compositions shown in Table 1 were all processed in the manner described above.

TABLE 1
Example using triclinic aluminum silicate
without further flame retardant

| | | Ex.1 | Comp. 1 |
|---|---|---|---|
| a/1 | [%] | 24.69 | 24.69 |
| b/1 | [%] | 75 | |
| b/2 | [%] | | 75 |
| f | [%] | 0.31 | 0.31 |
| IZOD | [kJ/m²] | 23 | 10 |
| Flexural strength | [Mpa] | 161 | 140 |
| Edge fiber elongation | [%] | 1.9 | 1.1 |
| GWFI (1.5 mm) at 750° C. | | passed | passed |
| GWFI (3 mm) at 960° C. | | passed | passed |
| Commencement of | [° C.] | 360 | 320 |
| decomposition | | | |

Compositions according to the invention and products obtainable therefrom (Ex.1) thus display a very much higher decomposition temperature and thus a significantly wider processing window at a comparable glow wire performance compared to the variant using a flame retardant (here magnesium hydroxide) (Comp.1).

A GWFI of 750° C. meets, in accordance with IEC60335-1, the standardized requirements for use as insulating material for electric current-conducting parts at >0.5 A in domestic appliances subject to supervision. The use of aluminum silicate at the same filler content results in significantly better mechanical properties.

1. A composition comprising:
a) 20 to 90% by weight of at least one polyamide; and
b) 10 to 80% by weight of at least one electrically insulating, thermally conductive filler selected from the group consisting of
b1) aluminum oxide,
where the sum total of all the percentages by weight is always 100.

2. The composition as claimed in claim 1, wherein the component b1) is in the form of fine needles, platelets, spheres, or irregularly shaped particles.

3. The composition as claimed in claim 2, wherein the particle sizes of the component b1) is are 0.1 to 300 μm.

4. The composition as claimed in claim 2, wherein the thermal conductivity of the component b1) is 10 to 400 W/mK.

5. (canceled)

6. (canceled)

7. (canceled)

8. The composition as claimed in claim 1, further comprising:
c) 5 to 70% by weight, based on the total composition, of glass fibers, where the amounts of the other components are reduced to such an extent that the sum of all the percentages by weight is always 100.

9. The composition as claimed in claim 8, wherein the glass fibers are provided with a size system or a bonding agent, or bonding agent system, particularly preferably one based on silane.

10. The composition as claimed in claim 8, further comprising:
d) 0.01 to 3% by weight, based on the total composition, of at least one thermal stabilizer, where the amounts of the other components are reduced to such an extent that the sum of all percentages by weight is always 100.

11. The composition as claimed in claim 10, wherein the thermal stabilizer is selected from the group consisting of sterically hindered phenols, which are compounds which have a phenolic structure and have at least one bulky group on the phenolic ring, preferably sterically hindered phenols of the formula (II), 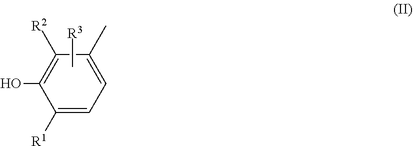
where R¹ and R² are each an alkyl group, a substituted alkyl group or a substituted triazole group, where the radicals R¹ and R² can be identical or different, and R³ is an alkyl group, a substituted alkyl group, an alkoxy group or a substituted amino group.

12. The composition as claimed in claim 1, further comprising at least one of:
c) 5 to 70% by weight, based on the total composition, of glass fibers,
d) 0.01 to 3% by weight, based on the total composition, of at least one thermal stabilizer, and
e) 1 to 40% by weight, based on the total composition, of at least one flame retardant,
where the amounts of the other components are reduced to such an extent that the sum of all percentages by weight is always 100, preferably organic halogen compounds with synergists or organic nitrogen compounds or organic/inorganic phosphorus compounds, which are used individually or in admixture with one another.

13. A process for producing a composition as claimed in claim 1, the process comprising mixing the components a) and b) with one another in a mixing apparatus.

14. The process as claimed in claim 13, further comprising mixing of the components in a melt at a temperature of 240 to 300° C.

15. The process as claimed in claim 14, the wherein the mixing is carried out in an extruder, and the process further comprises discharging the mixture as strand through at least one extruder outlet, cooling the strand until it is pelletizable, and pelletizing the strand.

16. A molding composition obtained by the process as claimed in claim 13.

17. A pelletized material obtained by the process as claimed in claim 15.

18. A product, in particular a semifinished part or shaped part, obtained by extrusion or injection molding of the molding compositions as claimed in claim 16.

19. A method for producing products with relatively high flame resistance, the method comprising producing the products from the composition as claimed in claim 1 without additional flame retardants based on halogen-, nitrogen- or phosphorus-containing organic compounds or red phosphorus.

20. The method as claimed in claim 19, forming the products by extrusion or injection molding of the composition as claimed in claim 1.
